(19) United States
(12) Patent Application Publication
(10) Pub. No.: US 2025/0386378 A1
(43) Pub. Date: Dec. 18, 2025

(54) RANDOM ACCESS METHOD AND DEVICE

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 18/877,179

(22) PCT Filed: Jun. 21, 2022
(86) PCT No.: PCT/CN2022/100244

§ 371 Date: Dec. 19, 2024

(51) Int. Cl. H04W 74/0833; H04W 72/23

(52) U.S. Cl. CPC H04W 74/0841; H04W 72/23

(57) ABSTRACT

A random access method, which is performed by a terminal, includes: determining that contention resolution is unsuccessful or not considering the contention resolution is unsuccessful, in a case where a contention resolution timer expires and a first condition is satisfied during a contention-based random access.

The present application is a U.S. National Stage of International Application No. PCT/CN2022/100244, filed on Jun. 21, 2022, the contents of all of which are incorporated herein by reference in their entirety for all purposes.

### BACKGROUND OF THE INVENTION

In a contention-based random access procedure, a contention resolution timer will be started after message 3 (Msg3) is transmitted by a terminal to a network device. When the contention resolution timer runs, Msg3 retransmission scheduling for addressing based on a temporary cell radio network temporary identifier (TC-RNTI) is monitored by the terminal on a physical downlink control channel (PDCCH). After the contention resolution timer expires, the terminal will consider that contention resolution is unsuccessful.

### SUMMARY OF THE INVENTION

The disclosure relates to the technical field of communication, and particularly relates to a random access method and a device.

In a first aspect, an example of the disclosure provides a random access method. The method is performed by a terminal. The method includes: determining that contention resolution is unsuccessful or not considering the contention resolution is unsuccessful, in a case where a contention resolution timer expires and a first condition is satisfied during a contention-based random access.

In a second aspect, an example of the disclosure provides another random access method. The method is performed by a terminal. The method includes: initiating a random access; transmitting a message 3 (Msg3) in the random access to a network device; and starting a monitoring timer after Msg3 initial transmission, in a case where the Msg3 is transmitted in NTN.

In a third aspect, an example of the disclosure provides a communication device. The communication device includes a processor and a memory. A computer program is stored in the memory. The computer program stored in the memory is executed by the processor, such that the method described in the first aspect mentioned is performed by the communication device.

In a four aspect, an example of the disclosure provides a communication device. The communication device includes a processor and a memory. A computer program is stored in the memory. The computer program stored in the memory is executed by the processor, such that the method described in the second aspect mentioned is performed by the communication device.

In a fifth aspect, an example of the disclosure provides a non-transitory computer-readable storage medium. The non-transitory computer-readable storage medium is configured to store instructions which is to be used by the terminal. When the instruction is executed, the method described in the first aspect mentioned is performed by the terminal.

In a sixth aspect, an example of the disclosure provides a non-transitory computer-readable storage medium. The non-transitory computer-readable storage medium is configured to store instructions which is to be used by the terminal. When the instruction is executed, the method described in the second aspect mentioned is performed by the terminal.

### BRIEF DESCRIPTION OF DRAWINGS

In order to more clearly explain the technical solutions in the examples of the disclosure or in the background art, the accompanying drawings required to be used in the examples of the disclosure or in the background art will be described below.

FIG. 1 is a schematic diagram of a non-terrestrial networks (NTN) communication mode according to an example of the disclosure.

FIG. 2 is a schematic diagram of another NTN communication mode according to an example of the disclosure.

FIG. 3 is a schematic diagram of yet another NTN communication mode according to an example of the disclosure.

FIG. 4 is an architecture diagram of a communication system according to an example of the disclosure.

FIG. 5 is a flow diagram of a random access method according to an example of the disclosure.

FIG. 6 is a flow diagram of another random access method according to an example of the disclosure.

FIG. 7 is a flow diagram of yet another random access method according to an example of the disclosure.

FIG. 8 is a flow diagram of still another random access method according to an example of the disclosure.

FIG. 9 is a structural diagram of a communication device according to an example of the disclosure.

FIG. 10 is a structural diagram of another communication device according to an example of the disclosure.

FIG. 11 is a schematic structural diagram of a chip according to an example of the disclosure.

### DETAILED DESCRIPTION OF THE INVENTION

In order to facilitate understanding of the disclosure, some concepts involved in examples of the disclosure will be briefly introduced here.

### 1. Random Access (RA)

A random access procedure refers to a procedure from time when a user (terminal) attempts to access a network (network device) by transmitting a random access preamble to time when a basic signaling connection to the network is established. Random access is an extremely critical step in a mobile communication system, and also a last step for establishing a communication link between the terminal and the network device. The terminal can exchange information with the network device through the random access. The random access procedure may include 2-step random access and 4-step random access.

The 4-step random access procedure includes: a random access preamble is transmitted by the terminal through a first message (Msg1). A random access response (RAR) message is transmitted by the network device through a second message (Msg2). A radio resource control (RRC) connection request is transmitted by the terminal through a third message (Msg3). Moreover, RRC connection establishment is received by the terminal through a fourth message (Msg4) (this procedure is actually a contention resolution procedure).

The 2-step random access procedure includes: message A (MsgA) is transmitted by the terminal to the network device. Message B (MsgB) is transmitted by the network device to the terminal. Specifically, MsgA includes content equivalent to Msg1 and Msg3 in the 4-step random access, and MsgB includes content equivalent to Msg2 and Msg4 in the 4-step random access.

### The Third Message (Msg3)

The third message in the 4-step random access procedure is referred to as Msg3. Moreover, Msg3 may have different content according to different states and application scenarios of the terminal. Specifically, Msg3 is required to contain one piece of important information: a unique identifier of each terminal. The identifier will be used for a fourth step of contention resolution in the 4-step random access.

In a contention-based random access procedure, a contention resolution timer is started after Msg3 is transmitted by the terminal. When the timer runs, Msg3 retransmission scheduling for addressing based on a temporary cell radio network temporary identifier (TC-RNTI), or Msg4 scheduling is monitored by the terminal on a physical downlink control channel (PDCCH). After the contention resolution timer expires, the terminal considers that contention resolution is unsuccessful.

### 2. a Non-Terrestrial Networks (NTN) Communication Mode is Shown in FIG. 1.

Specifically, NTN communication can be divided into a transparent payload and a regenerative payload according to different satellite signal processing modes.

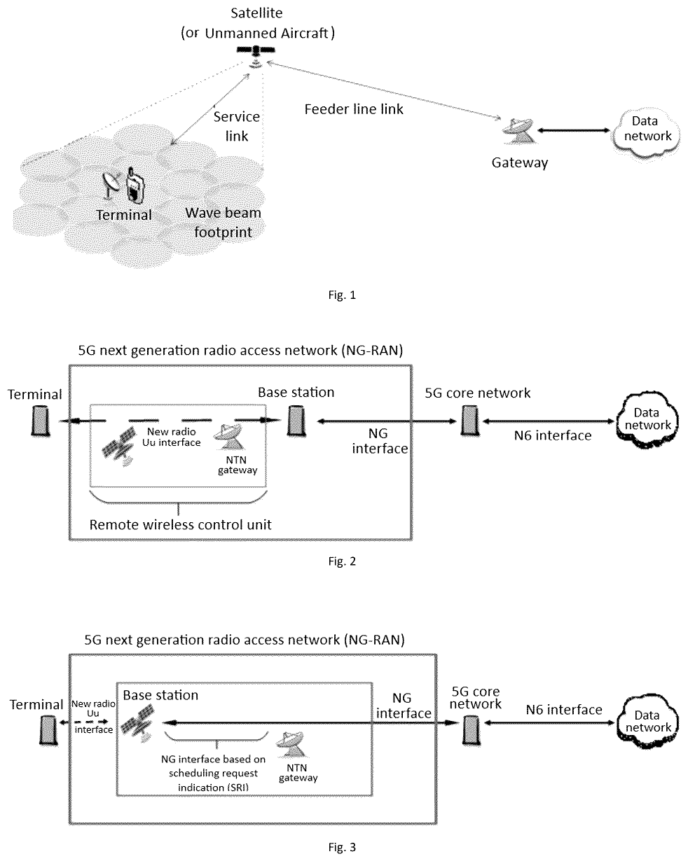

The transparent payload is shown in FIG. 2. A base station signal is transmitted by an NTN ground station to a satellite. The signal is converted by the satellite to a satellite frequency band and then transmitted to a terminal (terminal device) through the satellite frequency band. Except for frequency conversion and signal amplification, the base station signal is not demodulated by the satellite.

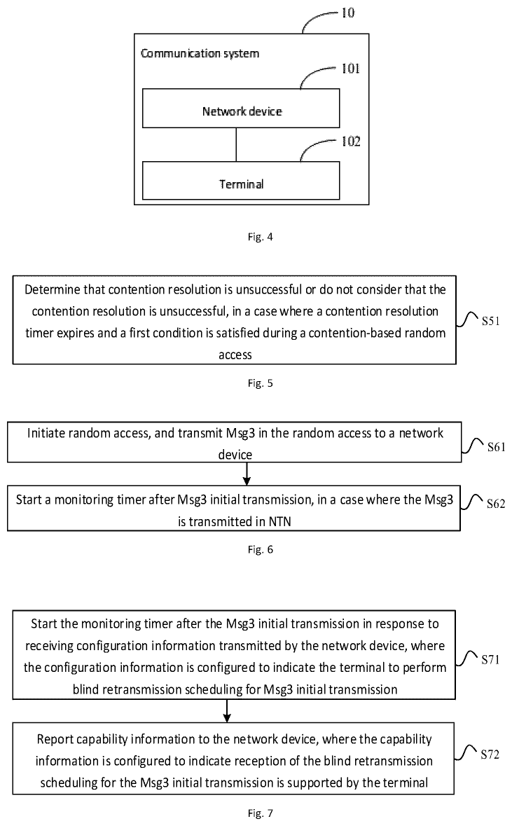

The regenerative payload is shown in FIG. 3. After the base station signal is transmitted by the NTN ground station to the satellite, the signal is demodulated and decoded by the satellite and then re-encoded and modulated. Moreover, a regenerated signal is transmitted through the satellite frequency band.

Satellite altitudes, orbits and satellite coverage for typical NTN are given in Table 1 described below.

TABLE 1

| | | | | Typical wave beam |
|---|---|---|---|---|
| Platforms | Altitude ranges | | Orbits | projection sizes |
| Low earth orbit | 300-1500 | km | Earth circular orbit | 100-1000 km |
| satellite | | | | |
| Medium earth | 7000-25000 | km | | 100-1000 km |
| orbit satellite | | | | |
| High earth orbit | 35786 | km | Maintain the same | 200-3500 km |
| satellite | | | pitch angle relative | |
| High altitude | 8-50 km (20 km in | | to the ground station | 5-200 km |
| platforms | cases of HAPSs) | | | |
| (including high | | | | |
| altitude platform | | | | |
| stations (HAPSs)) | | | | |
| Near high earth | 400-50000 | km | Earth elliptical orbit | 200-3500 km |

orbit satellite

In cases of the NTN, after the msg3 is transmitted and a round-trip time (RTT) is passed, the contention resolution timer is started.

### 3. Scrambling

Scrambling is a method for processing a digital signal. A new signal is obtained by carrying out exclusive or operation on scrambling code and an original signal. Generally, uplink physical channel scrambling is used to distinguish different terminal, and downlink scrambling can distinguish cells and channels. The scrambling code may be used to scramble and descramble the original signal. For instance, the scrambling code may be used for scrambling of downlink control information (DCI), which may also be referred to as scrambling of a PDCCH. Specifically, scrambling of the DCI may refer to scrambling of a cyclic redundancy check (CRC) field of the DCI. Correspondingly, the received DCI is descrambled by the terminal. Specifically, the CRC field of the DCI is descrambled by the terminal by using scrambling code of a corresponding type such that a format or type of the DCI can be determined.

The scrambling code may include but is not limited to: a cell radio network temporary identifier (C-RNTI), a temporary cell radio network temporary identifier (TC-RNTI), a random access radio network temporary identifier (RA-RNTI), a system information radio network temporary identifier (SI-RNTI) and a paging radio network temporary identifier (P-RNTI).

### a) C-RNTI and TC-RNTI

If the terminal is in a radio resource control connected (RRC-connected) state, it is indicated that a C-RNTI is allocated to the terminal, and the C-RNTI is required to be carried when a random access request is initiated by the terminal to the network device. If the terminal is in an RRC idle state or an RRC inactive state, it is indicated that no C-RNTI is allocated to the terminal. If an RRC connection is requested by the terminal, a temporary C-RNTI may be allocated by the network device to the terminal in subsequent response information, and is recorded as a TC-RNTI. After the random access of the terminal succeeds, the TC-RNTI can be converted into a C-RNTI.

### b) RA-RNTI

In a random access procedure, generation of the RA-RNTI is related to a time-frequency resource used by the terminal to transmit a preamble. For instance, when random access is initiated by terminal A and terminal B by using the same random access channel time-frequency resource, corresponding RA-RNTIs are the same.

### 4. Mapping Type of Physical Uplink Shared Channel (PUSCH)

A PUSCH includes two mapping types: Type A and Type B. The mapping type may be understood as a resource allocation type. In a communication standard of new radio (NR), Type A and Type B each indicate a starting symbol (identified as S), a symbol length (identified as L), and a range of possible values of S+L. For instance, valid S and L combinations in cases of Type A and Type B are shown in Table 6.1.2.1-1 (denoted as Table 2 in the disclosure) in Section 6.1.2.1 of Technical Standard (TS) 38.214 of the 3rd generation partnership project (3GPP).

### Table 2: Valid S and L Combinations

TABLE 2

| Mapping | | | | | | |
|---|---|---|---|---|---|---|
| type of | Normal cyclic prefix | | | Extended cyclic prefix | | |
| PUSCH | S | L | S + L | S | L | S + L |
| Type A | 0 | {4, . . . , 14} | {4, . . . , 14} | 0 | {4, . . . , 12} | {4, . . . , 12} |
| Type B | {0, . . . , 13} | {1, . . . , 14} | {1, . . . , 14} | {0, . . . , 11} | {1, . . . , 12} | {1, . . . , 12} |
| | | | {1, . . . , 27} | | | {1, . . . , 23} |

Parameters in a Type A row are suitable for repetition Type A. Moreover, “{1, . . . , 14}” and “{1, . . . , 12}” in an S+L column of a Type B row are suitable for repetition Type A, and “{1, . . . , 27}” and “{1, . . . , 23}” in an S+L column of the Type B row are suitable for repetition Type B.

### 5. Repeated Transmission of PUSCH

Repeated transmission of a PUSCH refers to transmission of a plurality of PUSCHs. The plurality of PUSCHs are a plurality of pieces of identical uplink data. Transmission of one PUSCH (that is, one piece of uplink data) may be referred to as one time of repeat transmission of a PUSCH. The plurality of pieces of identical uplink data refer to a plurality of identical or different redundancy versions (RVs) obtained by carrying out channel coding on the same systematic bit.

In a case of Type B, a number of repetitions is configured by introducing parameter “number of repetitions-r16” in the communication standard. Specifically, number of repetitions-r16 has 8 configurable values in total, which are indicated by 3 bits. Various values of the 3 bits correspond to {n1, n2, n3, n4, n7, n8, n12, n16} in sequence. A numerical value after n represents a number of repetitions. For instance, n1 indicates 1 time of transmission, and n16 indicate 16 times of transmission. One of the 8 configurable values mentioned may be configured by the network device for the terminal through a high-layer signaling, such as an RRC signaling, such that a number of repetitions can be indicated for the terminal. In a case of Type B, starting from start symbol S in a start time slot of repeated transmission of a PUSCH, L*number of repetitions-r16 available symbols are all used for the repeated transmission of the PUSCH. Specifically, “*” in the disclosure refers to “multiplied by”.

In a case of Type A, S+L is less than or equal to 14. When the terminal is configured with a number (assumed to be R1) of repetitions, detection is carried out by the terminal in each of R1 time slots (R1 continuous time slots starting from a start time slot). If L symbols starting from start symbol S in a time slot are all available symbols, the PUSCH is transmitted in the time slot. Otherwise, transmission of the PUSCH is given up, and whether other time slots satisfy conditions is continued to be determined.

Contention resolution timer is restarted repeatedly because the scheduling of Msg3 retransmission is received repeatedly. Before the contention resolution timer is restarted, the contention resolution timer started previously probably expires. In this case, the terminal will consider that contention fails. However, since the contention resolution timer will be restarted upon receiving the scheduling of Msg3 retransmission, the terminal should not consider that the contention fails at this point. Thus, this is an urgent problem to be solved.

Examples of the disclosure provide a random access method and a device, which can prevent a terminal from erroneously determining that contention resolution fails.

In the technical solution, the terminal determines that contention resolution is unsuccessful or do not considers the contention resolution is unsuccessful, in a case where a contention resolution timer expires and a first condition is satisfied during a contention-based random access. Thus, the terminal can be prevented from erroneously determining that the contention resolution fails.

In order to better understand a random access method and a device disclosed in examples of the disclosure, a communication system for which the examples of the disclosure are suitable will be first described below.

With reference to FIG. 4, a schematic architecture diagram of a communication system according to an example of the disclosure is shown in FIG. 4. The communication system may include but is not limited to one network device and one terminal. A number and a form of devices shown in FIG. 4 are merely used as instances and do not constitute limitations on examples of the disclosure. During actual application, two or more network devices and two or more terminals may be included. For instance, the communication system 10 shown in FIG. 4 includes one network device 101 and one terminal 102.

It should be noted that the technical solution of an example of the disclosure can be applied to various communication systems, such as: a long term evolution (LTE) system, a 5th generation (5G) mobile communication system, a 5G new radio (NR) system, or other future novel mobile communication systems. It should also be noted that a side link in an example of the disclosure may also be referred to as a sidelink or a direct-connection link.

The network device 101 in an example of the disclosure is an entity, which is used to transmit or receive signals, on a network side. For instance, the network device 101 may be an evolved node B (eNB), a transmission reception point (TRP), a next generation node B (gNB) in a new radio (NR) system, a base station in other future mobile communication systems, or an access node in a wireless fidelity (WiFi) system. A specific technology and specific device form used for the base station are not limited in an example of the disclosure. The base station provided in an example of the disclosure may include a central unit (CU) and a distributed unit (DU). The CU may also be referred to as a control unit. By using a CU-DU structure, a base station, for instance, protocol layers of the base station, can be split. Functions of some protocol layers are controlled by the CU in a centralized manner. Functions of some or all of the remaining protocol layers are distributed in the DU. The DU is controlled by the CU in a centralized manner.

The terminal 102 in an example of the disclosure is an entity such as a mobile phone, which is used to receive or transmit a signal, on a user side. The terminal may also be referred to as a terminal, user equipment (UE), a mobile station (MS), a mobile terminal (MT), etc. The terminal may be an automobile having a communication function, a smart automobile, a mobile phone, a wearable device, a portable android device (Pad), a computer having a wireless transceiving function, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, etc. A specific technology and specific device form used for the terminal are not limited in an example of the disclosure.

It can be understood that the communication system described in an example of the disclosure are used to more clearly explain the technical solution of the example of the disclosure, and do not constitute a limitation on the technical solution provided in the example of the disclosure. Those of ordinary skill in the art can know that as system architectures evolve and new service scenarios appear, the technical solution provided in the example of the disclosure is also applicable to similar technical problems.

A random access method and a device provided in the disclosure will be described in detail below in combination with the accompanying drawings.

With reference to FIG. 5, a flow diagram of a random access method according to an example of the disclosure is shown in FIG. 5.

As shown in FIG. 5, the method is performed by a terminal. The method may include, but is not limited to, the following steps S51.

S51: It is determined that contention resolution is unsuccessful or it is not considered the contention resolution is unsuccessful, in a case where a contention resolution timer expires and a first condition is satisfied during a contention-based random access.

In some examples, a contention-based random access procedure is carried out by the terminal, and a contention-based random access request is transmitted to the network device. The random access request includes message 3 (Msg3).

In an example of the disclosure, a contention-based random access procedure is carried out by the terminal. After message 3 (Msg3) is transmitted by the terminal to the network device, a ra-contention resolution timer is started. When the contention resolution timer runs, Msg3 retransmission scheduling for addressing based on a temporary cell radio network temporary identifier (TC-RNTI), or message (Msg) 4 scheduling is monitored by the terminal on a physical downlink control channel (PDCCH). After the contention resolution timer expires and under the condition that the first condition is satisfied, it is determined that the contention resolution is unsuccessful or it is not considered that the contention resolution is unsuccessful.

The first condition may be a condition for determining that the contention resolution is unsuccessful, or a condition for not considering that the contention resolution is unsuccessful. Thus, whether the contention resolution succeeds can be determined according to the first condition. The terminal can be prevented from erroneously determining that the contention resolution fails.

In some examples, the first condition includes at least one of: a Msg3 retransmission scheduled based on a temporary cell radio network temporary identifier (TC-RNTI) is not received on a physical downlink control channel (PDCCH) after a last start before the contention resolution timer expires, in a case where the Msg3 is transmitted in a non-terrestrial network (NTN); the Msg3 retransmission scheduled based on the TC-RNTI is not received on the PDCCH after the last start before the contention resolution timer expires, in a case where the Msg3 is transmitted in the NTN, wherein the contention resolution timer is started after delaying a round-trip time (RTT), subsequent to the Msg3 being transmitted; the Msg3 retransmission scheduled based on the TC-RNTI is not received on the PDCCH after the contention resolution timer is started, in a case where the Msg3 is transmitted in the NTN, wherein the contention resolution timer is started after delaying the RTT, subsequent to the Msg3 being transmitted; the Msg3 retransmission scheduled based on the TC-RNTI is not received on the PDCCH after the last start before the contention resolution timer expires, in a case where the Msg3 is transmitted in the NTN and the contention resolution timer is not to be started; or the Msg3 retransmission scheduled based on the TC-RNTI is not received on the PDCCH after the contention resolution timer is started, in a case where the Msg3 is transmitted in the NTN and the contention resolution timer is not to be started.

In an example of the disclosure, the first condition may be as follows: a Msg3 retransmission scheduled based on a temporary cell radio network temporary identifier (TC-RNTI) is not received on a physical downlink control channel (PDCCH) after a last start before the contention resolution timer expires, in a case where the Msg3 is transmitted in a non-terrestrial network (NTN). During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

In an example of the disclosure, the first condition may be as follows: the Msg3 retransmission scheduled based on the TC-RNTI is not received on the PDCCH after the last start before the contention resolution timer expires, in a case where the Msg3 is transmitted in the NTN, wherein the contention resolution timer is started after delaying a round-trip time (RTT), subsequent to the Msg3 being transmitted. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

In an example of the disclosure, the first condition may be as follows: the Msg3 retransmission scheduled based on the TC-RNTI is not received on the PDCCH after the contention resolution timer is started, in a case where the Msg3 is transmitted in the NTN, wherein the contention resolution timer is started after delaying the RTT, subsequent to the Msg3 being transmitted. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

In an example of the disclosure, the first condition may be as follows: the Msg3 retransmission scheduled based on the TC-RNTI is not received on the PDCCH after the last start before the contention resolution timer expires, in a case where the Msg3 is transmitted in the NTN and the contention resolution timer is not to be started. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

In an example of the disclosure, the first condition may be as follows: the Msg3 retransmission scheduled based on the TC-RNTI is not received on the PDCCH after the contention resolution timer is started, in a case where the Msg3 is transmitted in the NTN and the contention resolution timer is not to be started. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

The last start before the contention resolution timer expires may mean that the contention resolution timer is started after the Msg3 is transmitted by the terminal. After at least one time of Msg3 retransmission scheduled based on the TC-RNTI is received on the PDCCH, and the Msg3 retransmission scheduling is received, the Msg3 is transmitted by the terminal again. Then, the contention resolution timer is started again. When the contention resolution timer is started this time, the contention resolution timer previously started may not expire. On this basis, the last start before the contention resolution timer expires can be determined.

The contention resolution timer is not to be started, which may mean that no Msg3 retransmission scheduled based on the TC-RNTI is received by the terminal on the PDCCH. In a case that the Msg3 retransmission scheduling is not received, it can be determined that the contention resolution timer is not to be started.

It should be noted that the examples are not exhaustive, and are merely illustrative of some examples. Moreover, the examples may be independently implemented, or a plurality of the examples may be combined to be implemented. The examples are merely illustrative, and are not regarded as specific limitations on protection scopes of examples of the disclosure.

In some examples, the first condition includes at least one of: the contention resolution timer expires before a moment when a first symbol after Msg3 initial transmission ends plus the RTT, in a case where the terminal is in the NTN; the contention resolution timer expires before a moment when a first symbol after scheduled Msg3 retransmission ends plus the RTT, in a case where the terminal is in the NTN; the contention resolution timer expires before a moment when a first symbol after all repeated transmission of the Msg3 initial transmission ends plus the RTT, in a case where the terminal is in the NTN, where the Msg3 is repeatedly scheduled by using a Type A physical uplink shared channel (PUSCH); the contention resolution timer expires before a moment when a first symbol after all repeated transmission of the scheduled Msg3 retransmission ends plus the RTT, in a case where the terminal is in the NTN, where the Msg3 is scheduled by using a Type A PUSCH repetition; the contention resolution timer expires before a moment when the first symbol after the Msg3 initial transmission ends plus the RTT, and Msg3 retransmission scheduling is received by the terminal on the PDCCH, in a case where the terminal is in the NTN; or the contention resolution timer expires before a moment when a first symbol after Msg3 retransmission ends plus the RTT, and the Msg3 retransmission scheduling is received by the terminal on the PDCCH, in a case where the terminal is in the NTN.

In an example of the disclosure, the first condition may be as follows: the contention resolution timer expires before a moment when a first symbol after Msg3 initial transmission ends plus the RTT, in a case where the terminal is in the NTN. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

In an example of the disclosure, the first condition may be as follows: the contention resolution timer expires before a moment when a first symbol after scheduled Msg3 retransmission ends plus the RTT, in a case where the terminal is in the NTN. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

In an example of the disclosure, the first condition may be as follows: the contention resolution timer expires before a moment when a first symbol after all repeated transmission of the Msg3 initial transmission ends plus the RTT, in a case where the terminal is in the NTN, where the Msg3 is repeatedly scheduled by using a Type A physical uplink shared channel (PUSCH). During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

In an example of the disclosure, the first condition may be as follows: the contention resolution timer expires before a moment when a first symbol after all repeated transmission of the scheduled Msg3 retransmission ends plus the RTT, in a case where the terminal is in the NTN, where the Msg3 is scheduled by using a Type A PUSCH repetition. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

In an example of the disclosure, the first condition may be as follows: the contention resolution timer expires before a moment when the first symbol after the Msg3 initial transmission ends plus the RTT, and Msg3 retransmission scheduling is received by the terminal on the PDCCH, in a case where the terminal is in the NTN. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

The contention resolution timer expires before a moment when a first symbol after Msg3 retransmission ends plus the RTT, and the Msg3 retransmission scheduling is received by the terminal on the PDCCH, in a case where the terminal is in the NTN. During contention-based random access, in cases that the contention resolution timer expires and the first condition mentioned is satisfied, the terminal determines that contention resolution is unsuccessful or do not considers that contention resolution is unsuccessful. Thus, the terminal can be prevented from erroneously determining that the contention resolution fails.

It should be noted that the examples are not exhaustive, and are merely illustrative of some examples. Moreover, the examples may be independently implemented, or a plurality of the examples may be combined to be implemented. The examples are merely illustrative, and are not regarded as specific limitations on protection scopes of examples of the disclosure.

By implementing examples of the disclosure, the terminal determines, in a case where during contention-based random access, a contention resolution timer expires and a first condition is satisfied, that the contention resolution is unsuccessful or do not considers that contention resolution is unsuccessful. Thus, the terminal can be prevented from erroneously determining that the contention resolution fails.

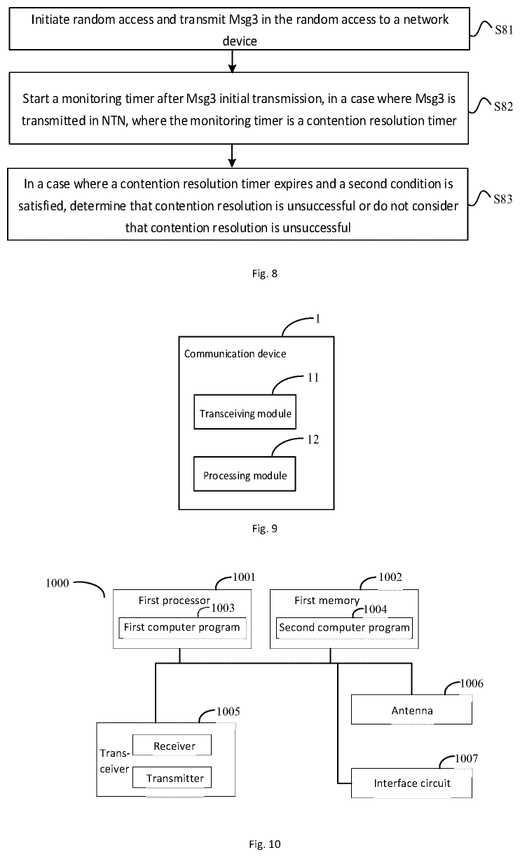

With reference to FIG. 6, a flow diagram of another random access method according to an example of the disclosure is shown in FIG. 6.

As shown in FIG. 6, the method is performed by a terminal. The method may include, but is not limited to, the following steps S61 and S62.

S61: Random access is initiated, and message 3 (Msg3) in the random access is transmitted to a network device.

S62: A monitoring timer is started after Msg3 initial transmission, in a case where the Msg3 is transmitted in NTN.

In an example of the disclosure, the random access is initiated by the terminal, and message 3 (Msg3) in the random access is transmitted to the network device. In a case that Msg3 is transmitted in the NTN, the monitoring timer is started by the terminal after the Msg3 initial transmission.

The monitoring timer may be started by the terminal after the Msg3 initial transmission such that blind retransmission scheduling for the Msg3 initial transmission can be supported by the terminal.

In some examples, the monitoring timer is an independent timer. The monitoring timer and a contention resolution timer are not the same timer.

In an example of the disclosure, the random access is initiated by the terminal, and message 3 (Msg3) in the random access is transmitted to the network device. In a case that Msg3 is transmitted in the NTN, an independent monitoring timer other than the contention resolution timer is started by the terminal after the Msg3 initial transmission. Thus, the blind retransmission scheduling for the Msg3 initial transmission can be supported by the terminal.

In some examples, the PDCCH is monitored when the monitoring timer runs.

In an example of the disclosure, the random access is initiated by the terminal, and message 3 (Msg3) in the random access is transmitted to the network device. In a case that Msg3 is transmitted in the NTN, an independent monitoring timer other than the contention resolution timer is started by the terminal after the Msg3 initial transmission. The PDCCH may be monitored by the terminal when the monitoring timer runs.

In some examples, the terminal is in a discontinuous reception (DRX) active state.

In an example of the disclosure, the random access is initiated by the terminal, and message 3 (Msg3) in the random access is transmitted to the network device. In a case that Msg3 is transmitted in the NTN, an independent monitoring timer other than the contention resolution timer is started by the terminal after the Msg3 initial transmission. The terminal is in the discontinuous reception (DRX) active state when the monitoring timer runs. Moreover, the PDCCH may be monitored by the terminal when the monitoring timer runs.

In some examples, the step that the PDCCH is monitored includes: scheduling based on a TC-RNTI or only Msg3 retransmission scheduling based on a TC-RNTI is monitored on the PDCCH.

In an example of the disclosure, the random access is initiated by the terminal, and message 3 (Msg3) in the random access is transmitted to the network device. In a case that Msg3 is transmitted in the NTN, an independent monitoring timer other than the contention resolution timer is started by the terminal after the Msg3 initial transmission. The PDCCH may be monitored by the terminal when the monitoring timer runs. The scheduling based on the TC-RNTI or only the Msg3 retransmission scheduling based on the TC-RNTI may be monitored by the terminal on the PDCCH.

In some examples, the method provided in an example of the disclosure further includes: timing duration of the monitoring timer is determined based on a first system message or a first radio resource control (RRC) message transmitted by the network device.

In an example of the disclosure, the first system message or the first radio resource control (RRC) message transmitted by the network device may be received by the terminal such that the timing duration of the monitoring timer can be determined.

A first system message of the network device in long term evolution (LTE) may be system information block (SIB) 31, SIB1 or SIB2. A first system message of the network device in new radio (NR) may be SIB19 or SIB1. The first RRC message may be a connection reconfiguration message (including a switching command), a connection establishment message, a connection re-establishment message, a connection recovery message or a connection release message, etc.

It should be noted that in an example of the disclosure, the random access is initiated by the terminal, and message 3 (Msg3) in the random access is transmitted to the network device. In a case that Msg3 is transmitted in the NTN, the monitoring timer is started by the terminal after the Msg3 initial transmission. During contention-based random access, in cases that the contention resolution timer expires and the first condition in some examples mentioned is satisfied, the terminal determines that contention resolution is unsuccessful or do not considers that contention resolution is unsuccessful. Thus, the terminal can be prevented from erroneously determining that the contention resolution fails.

In some examples, the monitoring timer may be a contention resolution timer. After message 3 (Msg3) in the random access is transmitted by the terminal to the network device, and Msg3 initial transmission is carried out, a contention resolution timer is started. When the contention resolution timer runs, scheduling based on the TC-RNTI or only Msg3 retransmission scheduling based on the TC-RNTI is monitored on the PDCCH.

After the Msg3 initial transmission is carried out by the terminal, the contention resolution timer is started. The contention resolution timer may be started immediately after the Msg3 initial transmission. That is, the contention resolution timer is not required to be started after the delay of the RTT.

It can be understood that after Msg3 initial transmission is carried out by the terminal, a contention resolution timer is started. Then, another contention resolution timer is started after a delay of the RTT after the Msg3 initial transmission. When the contention resolution timer runs, the scheduling based on the TC-RNTI or only the Msg3 retransmission scheduling based on the TC-RNTI is monitored on the PDCCH.

It should be noted that in an example of the disclosure, S61 and S62 may be independently implemented, or may be implemented along with any other steps in an example of the disclosure, for instance, implemented along with S51 in an example of the disclosure, which is not limited in an example of the disclosure.

It should be noted that in an example of the disclosure, the random access is initiated by the terminal, and message 3 (Msg3) in the random access is transmitted to the network device. In a case that Msg3 is transmitted in the NTN, the monitoring timer is started by the terminal after the Msg3 initial transmission. During contention-based random access, in cases that the contention resolution timer expires and the first condition in some examples mentioned is satisfied, the terminal determines that contention resolution is unsuccessful or do not considers that contention resolution is unsuccessful. Thus, the terminal can be prevented from erroneously determining that the contention resolution fails.

With reference to FIG. 7, a flow diagram of yet another random access method according to an example of the disclosure is shown in FIG. 7.

As shown in FIG. 7, the method is performed by a terminal. The method may include, but is not limited to, the following steps S71 and S72.

S71: The monitoring timer is started after the Msg3 initial transmission in response to receiving configuration information transmitted by the network device. The configuration information is configured to indicate the terminal to perform blind retransmission scheduling for Msg3 initial transmission.

It is conceivable that the blind retransmission scheduling for the Msg3 initial transmission is supported by the terminal. The terminal is required to additionally monitor a PDCCH, such that power consumption of the terminal will be increased.

On this basis, in an example of the disclosure, the monitoring timer is started by the terminal after the Msg3 initial transmission in response to receiving configuration information transmitted by the network device. The configuration information is configured to indicate the terminal to perform blind retransmission scheduling for Msg3 initial transmission.

In an example of the disclosure, in cases that the configuration information transmitted by the network device is received by the terminal, and the configuration information indicates the terminal to perform the blind retransmission scheduling for the Msg3 initial transmission, the monitoring timer is started by the terminal after Msg the initial transmission. Moreover, the PDCCH is monitored when the monitoring timer runs such that the blind retransmission scheduling for the Msg3 initial transmission can be supported.

In a case that no configuration information transmitted by the network device is received by the terminal, after the Msg3 initial transmission, the monitoring timer may not be started and the PDCCH may not be monitored. Thus, power consumption of the terminal can be reduced.

In some examples, the configuration information transmitted by the network device is received by the terminal, it may be that a second system message or a second radio resource control (RRC) message transmitted by the network device is received.

A second system message transmitted by the network device in long term evolution (LTE) may be system information block (SIB) 31, SIB1 or SIB2. A second system message transmitted by the network device in new radio (NR) may be SIB19 or SIB1. The second RRC message may be a connection reconfiguration message (including a switching command), a connection establishment message, a connection re-establishment message, a connection recovery message, or a connection release message, etc.

In some examples, in a case that the blind retransmission scheduling for the Msg3 initial transmission is supported by the terminal, the monitoring timer is started by the terminal after the Msg3 initial transmission. The terminal is in an idle state, a connected state or an inactive state.

In an example of the disclosure, the terminal may be in an idle state, an inactive state or a connected state.

S72: Capability information is reported to the network device. The capability information is configured to indicate reception of the blind retransmission scheduling for the Msg3 initial transmission is supported by the terminal.

In an example of the disclosure, the capability information is reported to the network device by the terminal. The capability information is configured to indicate reception of the blind retransmission scheduling for the Msg3 initial transmission is supported by the terminal.

On this basis, after the capability information reported by the terminal is received, configuration information enabling the blind retransmission scheduling for the Msg3 initial transmission can be transmitted to the terminal by the network device. The capability information may be reported by the terminal by being carried in Msg3/Msg5, or through an RRC message.

In some examples, the step that a monitoring timer is started after the Msg3 initial transmission includes at least one of: the monitoring timer is started at a first symbol after all repeated transmission after the Msg3 initial transmission ends, where the Msg3 is scheduled by using a Type A PUSCH repetition; or the monitoring timer is started at a first symbol after the Msg3 initial transmission, where the Msg3 is scheduled not using the Type A PUSCH repetition.

In an example of the disclosure, the random access is initiated by the terminal, and message 3 (Msg3) in the random access is transmitted to the network device. In a case that Msg3 is transmitted in the NTN, the monitoring timer is started by the terminal after the Msg3 initial transmission. The monitoring timer may be started by the terminal at a first symbol after all repeated transmission after the Msg3 initial transmission ends, where the Msg3 is scheduled by using a Type A PUSCH repetition.

In an example of the disclosure, the random access is initiated by the terminal, and message 3 (Msg3) in the random access is transmitted to the network device. In a case that Msg3 is transmitted in the NTN, the monitoring timer is started by the terminal after the Msg3 initial transmission. The monitoring timer may be started by the terminal at a first symbol after the Msg3 initial transmission, where the Msg3 is scheduled not using a Type A PUSCH repetition.

It should be noted that in an example of the disclosure, S71 and S72 may be independently implemented, or may be implemented along with any other step in an example of the disclosure, for instance, implemented along with S51 and/or S61 and S62 in an example of the disclosure, which is not limited in an example of the disclosure.

With reference to FIG. 8, a flow diagram of still another random access method according to an example of the disclosure is shown in FIG. 8.

As shown in FIG. 8, the method is performed by a terminal. The method may include, but is not limited to, the following steps S81-S83.

S81: Random access is initiated, and message 3 (Msg3) in the random access is transmitted to a network device.

S82: A monitoring timer is started after Msg3 initial transmission, in a case where Msg3 is transmitted in NTN, where the monitoring timer is a contention resolution timer.

S83: in a case where a contention resolution timer expires and a second condition is satisfied, it is determined that contention resolution is unsuccessful, or it is not considered that contention resolution is unsuccessful.

In the related art, in a contention-based random access procedure, a contention resolution timer is started after message 3 (Msg3) is transmitted by a terminal to a network device. When the contention resolution timer runs, Msg3 retransmission scheduling for addressing based on a temporary cell radio network temporary identifier (TC-RNTI) is monitored by the terminal on a physical downlink control channel (PDCCH). After the contention resolution timer expires, the terminal considers that contention resolution is unsuccessful.

However, in a case that the monitoring timer is a contention resolution timer, after message 3 (Msg3) in the random access is transmitted by the terminal to the network device, and the Msg3 initial transmission is carried out, the contention resolution timer is immediately started (not after the delay of the RTT). If no msg3 retransmission scheduling is received by the terminal on the PDCCH when the contention resolution timer runs, it cannot be considered that contention resolution fails. The reason is that the Msg3 retransmission scheduling is also monitored by the terminal on the PDCCH when the contention resolution timer, which is started after the delay of the RTT after the Msg3 initial transmission, runs. However, according to a condition for determining that contention resolution is unsuccessful in the related art, it is considered that contention resolution fails in this case.

On this basis, in an example of the disclosure, in a case where a contention resolution timer expires and a second condition is satisfied, it is determined that contention resolution is unsuccessful or it is not considered that contention resolution is unsuccessful by the terminal.

In an example of the disclosure, random access is initiated by the terminal, and message 3 (Msg3) in the random access is transmitted to the network device. A monitoring timer is started after the Msg3 initial transmission in a case where Msg3 is transmitted in NTN. The monitoring timer is a contention resolution timer. In cases that the contention resolution timer expires and the second condition is satisfied, it is determined that the contention resolution is unsuccessful or it is not considered that that contention resolution is unsuccessful by the terminal.

The second condition may be a condition for determining that the contention resolution is unsuccessful, or a condition for not considering that the contention resolution is unsuccessful. Thus, whether the contention resolution succeeds can be determined according to the second condition. The terminal can be prevented from erroneously determining that the contention resolution fails.

In some examples, the second condition includes at least one of: a Msg3 retransmission scheduled based on a temporary cell radio network temporary identifier (TC-RNTI) is not received on a physical downlink control channel (PDCCH) after a last start before the contention resolution timer expires; the Msg3 retransmission scheduled based on the TC-RNTI is not received on the PDCCH after the last start before the contention resolution timer expires, wherein the contention resolution timer is started after delaying a round-trip time (RTT), subsequent to the Msg3 being transmitted; the Msg3 retransmission scheduled based on the TC-RNTI is not received on the PDCCH after the contention resolution timer is started, wherein the contention resolution timer is started after delaying the RTT, subsequent to the Msg3 being transmitted; the Msg3 retransmission scheduled based on the TC-RNTI is not received on the PDCCH after the last start before the contention resolution timer expires, in a case the contention resolution timer is not to be started; or the Msg3 retransmission scheduled based on the TC-RNTI is not received on the PDCCH after the contention resolution timer is started, in a case the contention resolution timer is not to be started.

In an example of the disclosure, the second condition may be as follows: a Msg3 retransmission scheduled based on a temporary cell radio network temporary identifier (TC-RNTI) is not received on a physical downlink control channel (PDCCH) after a last start before the contention resolution timer expires. Random access is initiated by the terminal, message 3 (Msg3) in the random access is transmitted to the network device in the NTN, the contention resolution timer is started after the Msg3 initial transmission, and the terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

In an example of the disclosure, the second condition may be as follows: the Msg3 retransmission scheduled based on the TC-RNTI is not received on the PDCCH after the last start before the contention resolution timer expires, wherein the contention resolution timer is started after delaying a round-trip time (RTT), subsequent to the Msg3 being transmitted. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

In an example of the disclosure, the second condition may be as follows: the Msg3 retransmission scheduled based on the TC-RNTI is not received on the PDCCH after the contention resolution timer is started, wherein the contention resolution timer is started after delaying the RTT, subsequent to the Msg3 being transmitted. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

In an example of the disclosure, the second condition may be as follows: the Msg3 retransmission scheduled based on the TC-RNTI is not received on the PDCCH after the last start before the contention resolution timer expires, in a case the contention resolution timer is not to be started. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that the contention resolution is unsuccessful in cases that a contention resolution timer expires and a second condition is satisfied. Thus, the terminal can be prevented from erroneously determining that the contention resolution fails.

In an example of the disclosure, the second condition may be as follows: the Msg3 retransmission scheduled based on the TC-RNTI is not received on the PDCCH after the contention resolution timer is started, in a case the contention resolution timer is not to be started. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

The last start before the contention resolution timer expires may mean that the contention resolution timer is started after the Msg3 is transmitted by the terminal. After at least one time of Msg3 retransmission scheduled based on the TC-RNTI is received on the PDCCH, and the Msg3 retransmission scheduling is received, the Msg3 is transmitted by the terminal again. Then, the contention resolution timer is started again. When the contention resolution timer is started this time, the contention resolution timer previously started may not expire. On this basis, the last start before the contention resolution timer expires can be determined.

The contention resolution timer is not to be started, which may mean that no Msg3 retransmission scheduled based on the TC-RNTI is received by the terminal on the PDCCH. In a case that the Msg3 retransmission scheduling is not received, it can be determined that the contention resolution timer is not to be started.

It should be noted that the examples are not exhaustive, and are merely illustrative of some examples. Moreover, the examples may be independently implemented, or a plurality of the examples may be combined to be implemented. The examples are merely illustrative, and are not regarded as specific limitations on protection scopes of examples of the disclosure.

In some examples, the second condition includes at least one of: the contention resolution timer expires before a moment when a first symbol after Msg3 initial transmission ends plus RTT; the contention resolution timer expires before a moment when a first symbol after scheduled Msg3 retransmission ends plus the RTT; the contention resolution timer expires before a moment when a first symbol after all repeated transmission of the Msg3 initial transmission ends plus the RTT, where the Msg3 is repeatedly scheduled by using a Type A physical uplink shared channel (PUSCH); the contention resolution timer expires before a moment when a first symbol after all repeated transmission of the scheduled Msg3 retransmission ends plus the RTT, where the Msg3 is scheduled by using a Type A PUSCH repetition; the contention resolution timer expires before a moment when the first symbol after the Msg3 initial transmission ends plus the RTT, and Msg3 retransmission scheduling is received by the terminal on the PDCCH; or the contention resolution timer expires before a moment when a first symbol after Msg3 retransmission ends plus the RTT, and the Msg3 retransmission scheduling is received by the terminal on the PDCCH.

In an example of the disclosure, the second condition may be as follows: the contention resolution timer expires before a moment when a first symbol after Msg3 initial transmission ends plus RTT. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

In an example of the disclosure, the second condition may be as follows: the contention resolution timer expires before a moment when a first symbol after scheduled Msg3 retransmission ends plus the RTT. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

In an example of the disclosure, the second condition may be as follows: the contention resolution timer expires before a moment when a first symbol after all repeated transmission of the Msg3 initial transmission ends plus the RTT, where the Msg3 is repeatedly scheduled by using a Type A physical uplink shared channel (PUSCH). Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

In an example of the disclosure, the second condition may be as follows: the contention resolution timer expires before a moment when a first symbol after all repeated transmission of the scheduled Msg3 retransmission ends plus the RTT, where the Msg3 is scheduled by using a Type A PUSCH repetition. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

In an example of the disclosure, the second condition may be as follows: the contention resolution timer expires before a moment when the first symbol after the Msg3 initial transmission ends plus the RTT, and Msg3 retransmission scheduling is received by the terminal on the PDCCH. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

In an example of the disclosure, the second condition may be as follows: the contention resolution timer expires before a moment when a first symbol after Msg3 retransmission ends plus the RTT, and the Msg3 retransmission scheduling is received by the terminal on the PDCCH. Random access is initiated by the terminal, message 3 (Msg3) in the random access is transmitted to the network device in the NTN, and the contention resolution timer is started after the Msg3 initial transmission. The terminal determines that contention resolution is unsuccessful or do not considers that contention resolution is unsuccessful in cases that a contention resolution timer expires and a second condition is satisfied. Thus, the terminal can be prevented from erroneously determining that the contention resolution fails.

It should be noted that the examples are not exhaustive, and are merely illustrative of some examples. Moreover, the examples may be independently implemented, or a plurality of the examples may be combined to be implemented. The examples are merely illustrative, and are not regarded as specific limitations on protection scopes of examples of the disclosure.

By implementing examples of the disclosure, the terminal determines, in a case where during contention-based random access, a contention resolution timer expires and a second condition is satisfied, that the contention resolution is unsuccessful or do not considers that contention resolution is unsuccessful. Thus, the terminal can be prevented from erroneously determining that the contention resolution fails.

It should be noted that in an example of the disclosure, S81 to S83 may be independently implemented, or may be implemented along with any other step in an example of the disclosure, for instance, implemented along with S51 and/or S61 and S62 and/or S71 and S72 in an example of the disclosure, which is not limited in an example of the disclosure.

In the examples provided in the disclosure, the method provided in an example of the disclosure is introduced from the perspective of a terminal. In order to implement all functions in the method provided in the examples of the disclosure, the terminal may include a hardware structure and a software module. The functions are implemented by the hardware structure, the software module, or the hardware structure and the software module. One of the functions may be performed by the hardware structure, the software module, or the hardware structure and the software module.

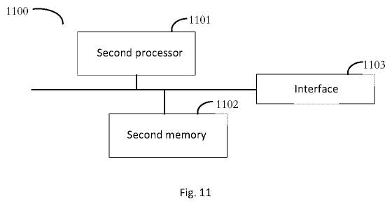

With reference to FIG. 9, a schematic structural diagram of a communication device 1 according to an example of the disclosure is shown. The communication device 1 shown in FIG. 9 may include a transceiving module 11 and a processing module 12. The transceiving module may include a transmitting module and/or a receiving module. The transmitting module is used to implement a transmitting function. The receiving module is used to implement a receiving function. The transceiving module may implement the transmitting function and/or the receiving function.

The communication device 1 may be a terminal, a device included in the terminal, or a device that can be used in cooperation with the terminal.

In some examples, the communication device 1 is a terminal.

The device includes a processing module 12.

The processing module 12 is configured to determine that contention resolution is unsuccessful or not consider contention resolution is unsuccessful, in a case where a contention resolution timer expires and a first condition is satisfied during contention-based random access.

In some examples, the communication device 1 further includes a transceiving module 11.

The transceiving module 11 is configured to transmit a contention-based random access request to a network device, where the random access request includes message 3 (Msg3).

In some examples, the first condition includes at least one of: a Msg3 retransmission scheduled based on a temporary cell radio network temporary identifier (TC-RNTI) is not received on a physical downlink control channel (PDCCH) after a last start before the contention resolution timer expires, in a case where the Msg3 is transmitted in a non-terrestrial network (NTN); the Msg3 retransmission scheduled based on the TC-RNTI is not received on the PDCCH after the last start before the contention resolution timer expires, in a case where the Msg3 is transmitted in the NTN, wherein the contention resolution timer is started after delaying a round-trip time (RTT), subsequent to the Msg3 being transmitted; the Msg3 retransmission scheduled based on the TC-RNTI is not received on the PDCCH after the contention resolution timer is started, in a case where the Msg3 is transmitted in the NTN, wherein the contention resolution timer is started after delaying the RTT, subsequent to the Msg3 being transmitted; the Msg3 retransmission scheduled based on the TC-RNTI is not received on the PDCCH after the last start before the contention resolution timer expires, in a case where the Msg3 is transmitted in the NTN and the contention resolution timer is not to be started; or the Msg3 retransmission scheduled based on the TC-RNTI is not received on the PDCCH after the contention resolution timer is started, in a case where the Msg3 is transmitted in the NTN and the contention resolution timer is not to be started.

In some examples, the first condition includes at least one of: the contention resolution timer expires before a moment when a first symbol after Msg3 initial transmission ends plus the RTT, in a case where the terminal is in the NTN; the contention resolution timer expires before a moment when a first symbol after scheduled Msg3 retransmission ends plus the RTT, in a case where the terminal is in the NTN; the contention resolution timer expires before a moment when a first symbol after all repeated transmission of the Msg3 initial transmission ends plus the RTT, in a case where the terminal is in the NTN, wherein the Msg3 is repeatedly scheduled by using a Type A physical uplink shared channel (PUSCH); the contention resolution timer expires before a moment when a first symbol after all repeated transmission of the scheduled Msg3 retransmission ends plus the RTT, in a case where the terminal is in the NTN, wherein the Msg3 is scheduled by using a Type A PUSCH repetition; the contention resolution timer expires before a moment when the first symbol after the Msg3 initial transmission ends plus the RTT, and Msg3 retransmission scheduling is received by the terminal on the PDCCH, in a case where the terminal is in the NTN; or the contention resolution timer expires before a moment when a first symbol after Msg3 retransmission ends plus the RTT, and the Msg3 retransmission scheduling is received by the terminal on the PDCCH, in a case where the terminal is in the NTN.

In some examples, the communication device 1 is a terminal.

The device includes a transceiving module 11 and a processing module 12.

The transceiving module 11 is configured to initiate random access, and transmit message 3 (Msg3) in the random access to a network device.

The processing module 12 is configured to start a monitoring timer after Msg3 initial transmission in a case where the Msg3 is transmitted in NTN.

In some examples, the monitoring timer is an independent timer. The monitoring timer and a contention resolution timer are not the same timer.

In some examples, the processing module 12 is further configured to monitor the PDCCH when the monitoring timer runs.

In some examples, the terminal is in a discontinuous reception (DRX) active state.

In some examples, the processing module 12 is further configured to monitor scheduling based on a TC-RNTI or only Msg3 retransmission scheduling based on a TC-RNTI on the PDCCH.

In some examples, the transceiving module 11 is further configured to determine timing duration of the monitoring timer based on a first system message or a first radio resource control (RRC) message transmitted by the network device.

In some examples, the monitoring timer is a contention resolution timer. The processing module 12 is further configured to monitor scheduling based on a TC-RNTI or only Msg3 retransmission scheduling based on a TC-RNTI on the PDCCH when the monitoring timer runs.

In some examples, the processing module 12 is further configured to start the monitoring timer after the Msg3 initial transmission in response to receiving configuration information transmitted by the network device. The configuration information is configured to indicate the terminal to perform blind retransmission scheduling for Msg3 initial transmission.

In some examples, the transceiving module 11 is further configured to receive a second system message or a second radio resource control (RRC) message transmitted by the network device.

In some examples, the processing module 12 is further configured to start the monitoring timer after the Msg3 initial transmission in a case where the blind retransmission scheduling for the Msg3 initial transmission is supported by the terminal. The terminal is in an idle state, a connected state or an inactive state.

In some examples, the transceiving module 11 is further configured to report capability information to the network device. The capability information is configured to indicate reception of the blind retransmission scheduling for the Msg3 initial transmission is supported by the terminal.

In some examples, the processing module 12 is further configured to start a monitoring timer after the Msg3 initial transmission, which includes at least one of: the monitoring timer is started at a first symbol after all repeated transmission after the Msg3 initial transmission ends, where the Msg3 is scheduled by using a Type A PUSCH repetition; or the monitoring timer is started at a first symbol after the Msg3 initial transmission, where the Msg3 is scheduled not using a Type A PUSCH repetition.

In some examples, the processing module 12 is further configured to determine that contention resolution is unsuccessful or not consider contention resolution is unsuccessful, in a case where a contention resolution timer expires and a second condition is satisfied.

In some examples, the second condition includes at least one of: a Msg3 retransmission scheduled based on a temporary cell radio network temporary identifier (TC-RNTI) is not received on a physical downlink control channel (PDCCH) after a last start before the contention resolution timer expires; the Msg3 retransmission scheduled based on the TC-RNTI is not received on the PDCCH after the last start before the contention resolution timer expires, wherein the contention resolution timer is started after delaying a round-trip time (RTT), subsequent to the Msg3 being transmitted; the Msg3 retransmission scheduled based on the TC-RNTI is not received on the PDCCH after the contention resolution timer is started, wherein the contention resolution timer is started after delaying the RTT, subsequent to the Msg3 being transmitted; the Msg3 retransmission scheduled based on the TC-RNTI is not received on the PDCCH after the last start before the contention resolution timer expires, in a case the contention resolution timer is not to be started; or the Msg3 retransmission scheduled based on the TC-RNTI is not received on the PDCCH after the contention resolution timer is started, in a case the contention resolution timer is not to be started.

In some examples, the second condition includes at least one of: the contention resolution timer expires before a moment when a first symbol after Msg3 initial transmission ends plus RTT; the contention resolution timer expires before a moment when a first symbol after scheduled Msg3 retransmission ends plus the RTT; the contention resolution timer expires before a moment when a first symbol after all repeated transmission of the Msg3 initial transmission ends plus the RTT, where the Msg3 is repeatedly scheduled by using a Type A physical uplink shared channel (PUSCH); the contention resolution timer expires before a moment when a first symbol after all repeated transmission of the scheduled Msg3 retransmission ends plus the RTT, where the Msg3 is scheduled by using a Type A PUSCH repetition; the contention resolution timer expires before a moment when the first symbol after the Msg3 initial transmission ends plus the RTT, and Msg3 retransmission scheduling is received by the terminal on the PDCCH; or the contention resolution timer expires before a moment when a first symbol after Msg3 retransmission ends plus the RTT, and the Msg3 retransmission scheduling is received by the terminal on the PDCCH.

A specific method through which each module of the communication device 1 in the examples executes an operation is described in detail in examples related to the method, and will not be described in detail here.

The communication device 1 provided in the examples of the disclosure achieves the same or similar beneficial effects as the random access method provided in some examples mentioned, which will not be repeated here.

With reference to FIG. 10, a schematic structural diagram of another communication device 1000 according to an example of the disclosure is shown in FIG. 10. The communication device 1000 may be a terminal, or a chip, a chip system, a processor, etc. which supports the terminal in implementation of the method. The communication device 1000 may be used to implement the method described in the method examples. Details can be obtained with reference to the descriptions in the method examples.

The communication device 1000 may include one or more first processors 1001. The first processor 1001 may be a general-purpose processor, a special-purpose processor, etc. For instance, the processor may be a baseband processor or a central processing unit. The baseband processor may be used to process communication protocols and communication data. The central processing unit may be used to control a communication device (such as a network device, a baseband chip, a terminal, a terminal chip, a distributed unit (DU) or a centralized unit (CU)), execute a computer program, and process data of the computer program.

In some examples, one or more first memories 1002 may be included in the communication device 1000. A second computer program 1004 may be stored in the memory. The second computer program 1004 is executed by the first memory 1002 such that the method described in the method examples can be performed by the communication device 1000. In some examples, data may be stored in the first memory 1002. The communication device 1000 and the first memory 1002 may be arranged independently or may be integrated together.

In some examples, the communication device 1000 may further include a transceiver 1005 and an antenna 1006. The transceiver 1005 may be referred to as a transceiving unit, a transceiving machine, or a transceiving circuit, and is used to implement a transceiving function. The transceiver 1005 may include a receiver and a transmitter. The receiver may be referred to as a receiving machine, a receiving circuit, etc., and is used to implement a receiving function. The transmitter may be referred to as a transmitting machine, a transmitting circuit, etc., and is used to implement a transmitting function.

In some examples, the communication device 1000 may further include one or more interface circuits 1007. The interface circuit 1007 is used to receive a code instruction and transmit the code instruction to the first processor 1001. The code instruction is run by the first processor 1001 such that the method described in the method examples can be performed by the communication device 1000.

The communication device 1000 is a terminal. The first processor 1001 is used to execute S51 in FIG. 5, S62 in FIG. 6, S71 in FIG. 7, and S82 and S83 in FIG. 8. The transceiver 1005 is used to execute S61 in FIG. 6, S71 in FIG. 7, and S81 in FIG. 8.

In an implementation, the first processor 1001 may include a transceiver used to implement receiving and transmitting functions. For instance, the transceiver may be a transceiving circuit, an interface or an interface circuit. The transceiving circuit, the interface or the interface circuit, which is used to implement receiving and transmitting functions, may be independent or integrated. The transceiving circuit, interface or interface circuit may be used to read and write code/data, or the transceiving circuit, interface or interface circuit may be used to transport or transfer a signal.

In an implementation, a first computer program 1003 may be stored in the first processor 1001. The first computer program 1003 is run on the first processor 1001 such that the method described in the method examples can be performed by the communication device 1000. The first computer program 1003 may be embedded in the first processor 1001. In this case, the first processor 1001 may be implemented by hardware.

In an implementation, the communication device 1000 may include a circuit. The transmitting, receiving or communication function in the method examples may be implemented by the circuit. The processor and transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be fabricated through various IC process technologies, such as a complementary metal oxide semiconductor (CMOS), an N-Metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the examples may be a terminal, but the scope of the communication device described in the disclosure is not limited to this. Moreover, the structure of the communication device may not be limited by FIG. 10. The communication device may be an independent device or a part of a large device. For instance, the communication device may be as follows: (1) an independent integrated circuit (IC), a chip, a chip system or a subsystem; (2) a set of one or more ICs, where in some examples, the IC set may also include a memory component used to store data and a computer program; (3) an ASIC, such as a modem; (4) modules that can be embedded in other devices; (5) a receiver, a terminal, an intelligent terminal, a cellular phone, a wireless device, a handset, a mobile unit, a vehicle-mounted device, a network device, a cloud device, an artificial intelligence device, etc.; and (6) other device.

A case that the communication device may be a chip or a chip system can be obtained with reference to FIG. 11, and a structural diagram of a chip according to an example of the disclosure is shown.

The chip 1100 includes a second processor 1101 and an interface 1103. One or more second processors 1101 may be arranged, and a plurality of interfaces 1103 may be arranged.

In a case that the chip is used to implement functions of a terminal in an example of the disclosure, the interface 1103 is used to receive a code instruction and transmit the code instruction to the processor.

The second processor 1101 is used to run the code instruction such that the random access method in some examples described can be performed.

In some examples, the chip 1100 further includes a second memory 1102. The second memory 1102 is used to store a necessary computer program and data.

Those skilled in the art will further know that various illustrative logical blocks and steps listed in examples of the disclosure may be implemented by electronic hardware, computer software, or their combinations. Whether such functions are implemented by hardware or software depends on particular application and design requirements of the entire system. Those skilled in the art can implement functions through various methods for each type of specific application. However, such implementation should not be understood as falling beyond the protection scopes of examples of the disclosure.

An example of the disclosure further provides a random access system. The system includes a communication device serving as a terminal and a communication device serving as a network device in the example of FIG. 9. Alternatively, the system includes a communication device serving as a terminal and a communication device serving as a network device in the example of FIG. 10.

The disclosure further provides a readable storage medium. An instruction is stored in the readable storage medium. When the instruction is executed by a computer, functions of any one of the method examples are implemented.

The disclosure further provides a computer program product. When the computer program product is performed by a computer, functions of any one of the method examples are implemented.

All or some of the examples may be implemented by software, hardware, firmware or their combinations. In a case that software is used for implementation, implementation may be entirely or partially carried out in a form of a computer program product. The computer program product includes one or more computer programs. When the computer program is loaded and executed on a computer, all or some of flows or functions according to examples of the disclosure are generated. The computer may be a general-purpose computer, a dedicated computer, a computer network, or another programmable device. The computer program may be stored in a non-transitory computer-readable storage medium or may be transmitted from a non-transitory computer-readable storage medium to another non-transitory computer-readable storage medium. For instance, the computer instructions may be transmitted from a website, computer, server, or data center to another website, computer, server, or data center in a wired manner (for instance, through a coaxial cable, an optical fiber, or a digital subscriber line (DSL)) or a wireless manner (for instance, through infrared rays, radio, or microwaves). The non-transitory computer-readable storage medium may be any available medium that can be accessed by the computer, or a data storage device, such as a server or a data center in which one or more usable media are integrated. The available medium may be a magnetic medium (such as a floppy disk, a hard disk and a magnetic tape), an optical medium (such as a digital video disc (DVD)), a semiconductor medium (such as a solid state disk (SSD)), etc.

Those of ordinary skill in the art can understand that various numerical numbers such as first and second involved in the disclosure are merely used for convenience of description, are not intended to limit the scopes of examples of the disclosure, and do not indicate sequence.

At least one in the disclosure may also be described as one or more, and a plurality of may be described as two, three, four, or more, which is not limited in the disclosure. In an example of the disclosure, technical features of a technical feature are distinguished by “first”, “second”, “third”, “A”, “B”, “C”, and “D”. The technical features described by “first”, “second”, “third”, “A”, “B”, “C”, and “D” are not in priority sequence or size sequence.

Corresponding relations shown in the tables in the disclosure may be configured or predefined. The values of information in each table are merely instances, and may be configured as other values, which is not limited in the disclosure. When a corresponding relation between the information and each parameter is configured, it is not certainly required to configure all corresponding relations indicated in each table. For instance, in tables in the disclosure, corresponding relations shown in some rows may not be configured. For instance, appropriate deformation adjustments can be made based on the tables, such as splitting and merging. Other names that can be understood by the communication device may be used as names of parameters shown in titles of the tables. Other values or expression modes that can be understood by the communication device may be used as values or expression modes of the parameters. When the tables are implemented, other data structures may be used, such as an array, a queue, a container, a stack, a linear table, a pointer, a linked list, a tree, a graph, a structure, a class, a heap, a hash table, and a hash table.

Predefinition in the disclosure may be understood as definition, predefinition, storage, prestorage, prenegotiation, preconfiguration, solidification, or prefiring.

Those of ordinary skill in the art can appreciate that units and algorithm steps described in combination with examples disclosed here can be implemented by electronic hardware, or a combination of computer software and electronic hardware. Whether these functions are performed by hardware or software depends on the specific application and design constraints of the technical solution. Those skilled in the art can implement the described functions through different methods for each particular application, but such implementation should not be considered as falling beyond the scope of the disclosure.

Those skilled in the art can clearly understand that for convenience and conciseness of description, the specific working process of the systems, devices and units described can be obtained with reference to the corresponding process in the methods examples, and will not be repeated here.

The embodiments are merely particular embodiments of the disclosure, but a protection scope of the disclosure is not limited to this. Any change or substitution that may be easily conceived by those skilled in the art within the technical scope disclosed by the disclosure should fall within the protection scope of the disclosure. Thus, the protection scopes of examples of the disclosure shall be subject to the protection scopes of the claims.

1. A random access method, performed by a terminal, comprising:
determining that contention resolution is unsuccessful or not considering the contention resolution is unsuccessful, in a case where a contention resolution timer expires and a first condition is satisfied during a contention-based random access.

2. The method according to claim 1, further comprising:
transmitting a contention-based random access request to a network device, wherein the random access request comprises message 3 (Msg3).

3. The method according to claim 2, wherein the first condition comprises at least one of:
a Msg3 retransmission scheduled based on a temporary cell radio network temporary identifier (TC-RNTI) is not received on a physical downlink control channel (PDCCH) after a last start before the contention resolution timer expires, in a case where the Msg3 is transmitted in a non-terrestrial network (NTN);
the Msg3 retransmission scheduled based on the TC-RNTI is not received on the PDCCH after the last start before the contention resolution timer expires, in a case where the Msg3 is transmitted in the NTN, wherein the contention resolution timer is started after delaying a round-trip time (RTT), subsequent to the Msg3 being transmitted; or
the Msg3 retransmission scheduled based on the TC-RNTI is not received on the PDCCH after the contention resolution timer is started, in a case where the Msg3 is transmitted in the NTN, wherein the contention resolution timer is started after delaying the RTT, subsequent to the Msg3 being transmitted.

4. The method according to claim 2, wherein the first condition comprises at least one of:
the contention resolution timer expires before a moment when a first symbol after Msg3 initial transmission ends plus a round-trip time (RTT), in a case where the terminal is in a non-terrestrial network (NTN);
the contention resolution timer expires before a moment when a first symbol after scheduled Msg3 retransmission ends plus the RTT, in a case where the terminal is in the NTN;
the contention resolution timer expires before a moment when a first symbol after all repeated transmission of the Msg3 initial transmission ends plus the RTT, in a case where the terminal is in the NTN, wherein the Msg3 is repeatedly scheduled by using a Type A physical uplink shared channel (PUSCH);
the contention resolution timer expires before a moment when a first symbol after all repeated transmission of the scheduled Msg3 retransmission ends plus the RTT, in a case where the terminal is in the NTN, wherein the Msg3 is scheduled by using a Type A PUSCH repetition;
the contention resolution timer expires before a moment when the first symbol after the Msg3 initial transmission ends plus the RTT, and Msg3 retransmission scheduling is received by the terminal on the PDCCH, in a case where the terminal is in the NTN; or
the contention resolution timer expires before a moment when a first symbol after Msg3 retransmission ends plus the RTT, and the Msg3 retransmission scheduling is received by the terminal on the PDCCH, in a case where the terminal is in the NTN.

5. A random access method, performed by a terminal, comprising:
initiating a random access;
transmitting a message 3 (Msg3) in the random access to a network device; and
starting a monitoring timer after Msg3 initial transmission, in a case where the Msg3 is transmitted in a non-terrestrial network (NTN).

6. The method according to claim 5, wherein the monitoring timer is an independent timer, and the monitoring timer and a contention resolution timer are not a same timer.

7. The method according to claim 5, further comprising:
monitoring scheduling based on a temporary cell radio network temporary identifier (TC-RNTI) or monitoring only Msg3 retransmission scheduling based on a TC-RNTI on a physical downlink control channel (PDCCH) when the monitoring timer runs, wherein the terminal is in a discontinuous reception (DRX) active state.

8-9. (canceled)

10. The method according to claim 5, further comprising:
determining a timing duration of the monitoring timer based on a first system message or a first radio resource control (RRC) message transmitted by the network device.

11. The method according to claim 97, wherein the monitoring timer is a contention resolution timer.

12. The method according to claim 7,
wherein starting the monitoring timer after the Msg3 initial transmission comprises:
starting, in response to receiving configuration information transmitted by the network device, the monitoring timer after the Msg3 initial transmission, wherein the configuration information is configured to indicate the terminal to perform blind retransmission scheduling for the Msg3 initial transmission; and
wherein receiving the configuration information transmitted by the network device comprises:
receiving a second system message or a second radio resource control (RRC) message transmitted by the network device.

13. (canceled)

14. The method according to claim 12, further comprising:
starting the monitoring timer after the Msg3 initial transmission in a case where the blind retransmission scheduling for the Msg3 initial transmission is supported by the terminal.

15. The method according to claim 12, further comprising:
reporting capability information to the network device, wherein the capability information is configured to indicate reception of the blind retransmission scheduling for the Msg3 initial transmission is supported by the terminal.

16. The method according to claim 5, wherein starting the monitoring timer after the Msg3 initial transmission comprises at least one of:
starting the monitoring timer at a first symbol after all repeated transmission after the Msg3 initial transmission ends, wherein the Msg3 is scheduled by using a Type A physical uplink shared channel (PUSCH) repetition; or
starting the monitoring timer at a first symbol after the Msg3 initial transmission, wherein the Msg3 is scheduled not using the Type A PUSCH repetition.

17. The method according to claim 5, further comprising:
determining that contention resolution is unsuccessful or not considering the contention resolution is unsuccessful, in a case where a contention resolution timer expires and a second condition is satisfied.

18. The method according to claim 17, wherein the second condition comprises at least one of:
a Msg3 retransmission scheduled based on a temporary cell radio network temporary identifier (TC-RNTI) is not received on a physical downlink control channel (PDCCH) after a last start before the contention resolution timer expires;
the Msg3 retransmission scheduled based on the TC-RNTI is not received on the PDCCH after the last start before the contention resolution timer expires, wherein the contention resolution timer is started after delaying a round-trip time (RTT), subsequent to the Msg3 being transmitted; or
the Msg3 retransmission scheduled based on the TC-RNTI is not received on the PDCCH after the contention resolution timer is started, wherein the contention resolution timer is started after delaying the RTT, subsequent to the Msg3 being transmitted.

19. The method according to claim 17, wherein the second condition comprises at least one of:
the contention resolution timer expires before a moment when a first symbol after Msg3 initial transmission ends plus a round-trip time (RTT);
the contention resolution timer expires before a moment when a first symbol after scheduled Msg3 retransmission ends plus the RTT;
the contention resolution timer expires before a moment when a first symbol after all repeated transmission of the Msg3 initial transmission ends plus the RTT, wherein the Msg3 is repeatedly scheduled by using a Type A physical uplink shared channel (PUSCH);
the contention resolution timer expires before a moment when a first symbol after all repeated transmission of the scheduled Msg3 retransmission ends plus the RTT, wherein the Msg3 is scheduled by using a Type A PUSCH repetition;
the contention resolution timer expires before a moment when the first symbol after the Msg3 initial transmission ends plus the RTT, and Msg3 retransmission scheduling is received by the terminal on a physical downlink control channel (PDCCH); or
the contention resolution timer expires before a moment when a first symbol after Msg3 retransmission ends plus the RTT, and the Msg3 retransmission scheduling is received by the terminal on the PDCCH.

20-21. (canceled)

22. A communication device, comprising:
a processor; and
a memory that stores a computer program, wherein the computer program stored in the memory, when executed by the processor, causes the communication device to:
determine that contention resolution is unsuccessful or not considering the contention resolution is unsuccessful, in a case where a contention resolution timer expires and a first condition is satisfied during a contention-based random access.

23. (canceled)

24. A non-transitory computer-readable storage medium storing instructions, wherein the instructions, when executed, implements the method according to claim 1.

25. A communication device, comprising:
a processor; and
a memory that stores a computer program, wherein the computer program stored in the memory, when executed by the processor, causes the communication device to perform the method according to claim 5.

26. A non-transitory computer-readable storage medium storing instructions, wherein the instructions, when executed by a processor, cause the processor to perform the method according to claim 5.
